(19) United States
(12) Patent Application Publication
(10) Pub. No.: US 2006/0156232 A1
(43) Pub. Date: Jul. 13, 2006

(54) Method and apparatus for preparing variable-data documents for publishing

(76) Inventors: Fabio Giannetti, Bristol (GB); Alexis Cabeda, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/293,906

(22) Filed: Dec. 5, 2005

(30) Foreign Application Priority Data
Dec. 7, 2004 (GB) 0426775.3

(51) Int. Cl. G06F 17/24; G06F 17/21

(52) U.S. Cl. 715/530; 715/517; 715/513

(57) ABSTRACT

A method and apparatus for preparing a variable-data document for publishing includes defining a plurality of data content areas within the document in which respective specified data objects are to be inserted, each data content area having a defined size; for each data content area defining one or more style parameters to be applied to the specified data object and defining one or more style modification parameters; associating a plurality of data content areas with one another; and if, after applying the or each style parameter to the specified data objects for each of a data content area associated with one another, one or more data objects exceed the size of the respective data object areas, then modifying the or each style parameter of each associated data content area in accordance with the respective style modification parameters.

Digital printing is well known and comprises of the transmission or transport of digital data representative of the document to be printed to a digital printer, which takes the document data and produces a hard copy, printed, version of the document. Users of personal computers either at work or at home will be familiar with digital printers in the form of inkjet and laser printers. However, digital printing is also used within the field of commercial printing, for example for the production of magazines or advertising literature. Digital printing is particularly attractive when only relatively small number of documents are required and particularly when those documents are highly personalised for the intended recipient.

One means of conveying the document data to a printer is by the use of a printer language. The document data is converted into the appropriate printer language, for example postscript, usually by the software application used to generate the original document. The printer language subsequently instructs the printer to create a rasterized image. Rasterization is a process of converting the data that describes the text and graphics into the format that is required by printers “print engine”, which is the machinery that actually puts the marks onto the page. Rasterization is performed by a “raster image processor”, also known as a RIP. With some systems, the RIP is a computer that is integral to the printer itself. Desktop printers, such as an inkjet printer, will typically have an integral RIP within the printer. With other systems, such as commercial printers, the RIP is separate from the printer. In this case, the RIP is implemented in software that runs on a computer separate from, but connected to, the printer. This process (ripping with the first RIP) must be repeated for each page of the document. High-volume print jobs can easily contain tens of thousands of pages that all have to be ripped. Ripping can become a problem as the amount of memory required for each page increases. For example, a single page with a colour photograph and title, together with text, can easily reach as much as 20 Mb in postscript. This costs an exceptional amount of processing power and memory space and is the most important cause of print processes not running correctly. It is for this reason that rated print engine speeds are often not met and printers may be ripping all night to be able to produce a reasonable print speed during the day.

This bottleneck in printing can be reduced by specifying reusable content. Reusable content are assets that are used on many of the pages within the same document. Reusable content can be fonts, logos, signatures, diagrams, images and the like. An object that is reusable is often referred to as a resource. By using appropriate printer language it is possible to identify which resources are needed at a particular point in a print job. This allows a resource to be rasterized once and used many times, instead of being rasterized on page on which it is used. An example of a print language for use with reusable content is PPML, personalised print mark-up language. PPML itself in fact only defines how existing resources are combined to create pages, documents and jobs e.g. PPML defines where on a page a graphic object is to appear and the space into which it must fit. However, the attributes of the resources themselves are defined by further documents, or files, expressed in existing mark-up languages, such as XSL-FO (Extensible Style Sheet Language Format Objects), to which the PPML document refers.

The use of print languages that specify resources to be used within a document also allow individual documents to be personalised or varied. Variable-data printing is a form of on-demand printing in which all the documents in the print room are similar but not identical. A simple example of this is the use of a mail-merge facility within a word-processor to allow individual names and addresses to be applied to the same basic letter. However, variable-data printing can go far beyond printing different names and addresses on a document. For example, there are many applications in which it is desirable to insert different graphics into a document, change the layout and/or the number of pages, print a unique barcode on each document, and more. The concept of creating variable-data documents has been extended to non-paper documents such as PDF documents and HTML documents. The term variable-data publishing encompasses both paper and electronic documents. Although languages such as PPML allow different resources to be inserted into individual documents within a print run, there remains the problem of ensuring that each individual resource fits within the space allowed for it in the document layout.

According to a first aspect of the present invention there is provided a method of preparing a variable-data document for publishing, the method comprising defining a plurality of data content areas within the document in which respective specified data objects are to be inserted, each data content area having a defined size, for each data content area defining one or more style parameters to be applied to the specified data object and defining one or more style modification parameters, associating a plurality of data content areas with one another, and if, after applying the or each style parameter to the specified data objects for each of a data content area associated with one another, one or more data objects exceeds the size of the respective data content areas, then modifying the or each style parameter of each associated data content area in accordance with the respective style modification parameters.

In some embodiments the same style parameter may be defined for each associated data content area. Additionally or alternatively, the same style modification parameters may be defined for each associated data content area.

Preferably, the step of modifying the style parameters for associated data content area is repeated until each data object fits within the respective data content area.

In some embodiments the data content area is expressed in PPML format. Similarly, the style parameters and style modification parameters may be expressed in XSL-FO format. The method may further comprise, subject to modifying the or each style parameter of rasterizing the document.

According to a second aspect of the present invention there is provided a computer program comprising a plurality of computer readable instructions that when executed by a computer cause the computer to perform the method according to the first aspect of the present invention.

The computer program is preferably embodied in a computer readable medium. According to a second aspect of the present invention there is provided an apparatus for preparing a variable-data document for publishing, the apparatus comprising a document processor and a document buffer, the document processor being arranged to: receive a plurality of data objects and to receive a plurality of input files, the input files defining a plurality of data content areas within the document, each data content area being associated with at least one other data content area. In which respective specified data objects are to be inserted, each data content area having a defined size, defining one or more style parameters to be applied to a specified data object and defining one or more style modification parameters, document processor being further arranged to apply the respective style parameters to each associated data object and storing the result in the document buffer, to determine if one or more data objects exceeds the size of the respective data content area, and if the size determination is positive, to retrieve the stored data objects from the document buffer and to modify the applied style parameters of each associated data content area in accordance with the respective style modification parameters.

Embodiments of the present invention will now be described, by way of illustrative example only, with reference to the accompanying figures, of which:

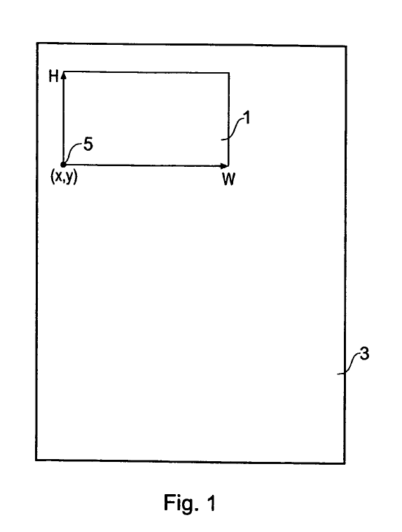

FIG. 1 illustrates the arrangement of a copy-hole on the page of a PPML;

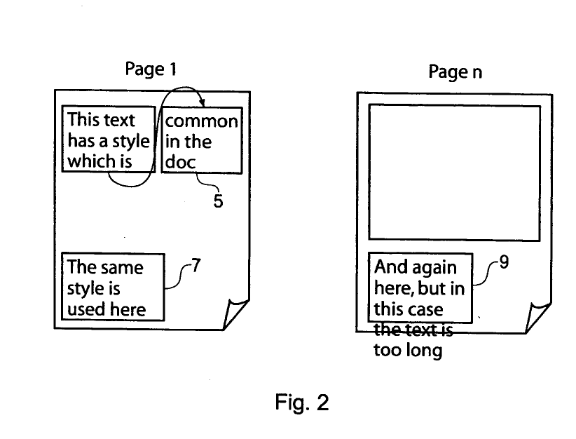

FIG. 2 schematically illustrates a plurality of copy-holes across a number of pages in a document in which at least one applied text object does not fit;

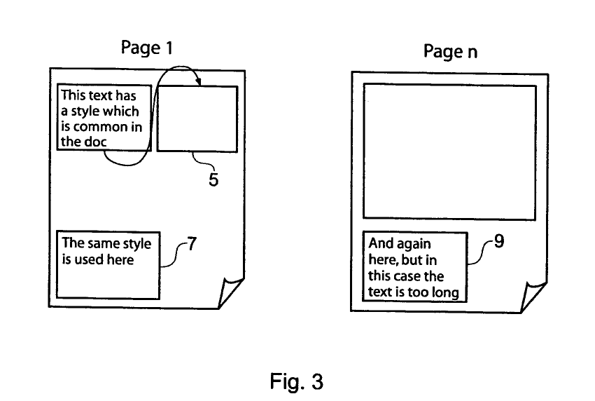

FIG. 3 schematically illustrates the copy-holes shown in FIG. 2 after the text object has been modified to fit;

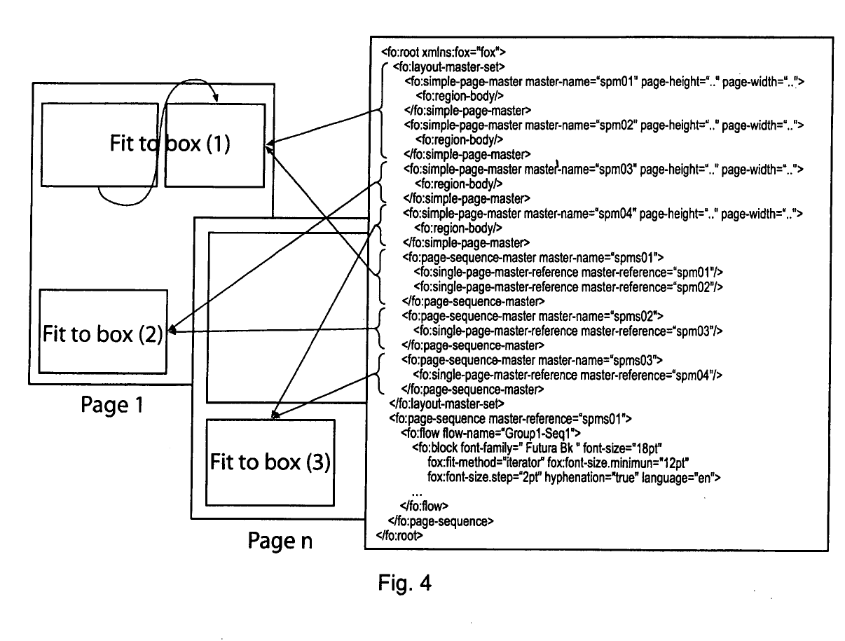

FIG. 4 schematically illustrates the copy-holes referred to in FIGS. 2 and 3, together with the associated page definition language;

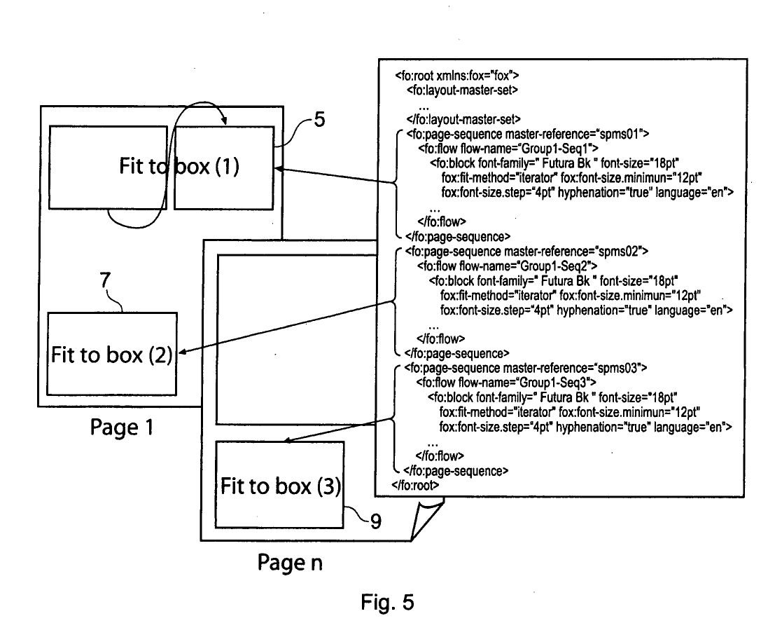

FIG. 5 illustrates the copy-holes referred to in FIG. 4, together with the page description language defining the style parameters to be used for the copy-holes;

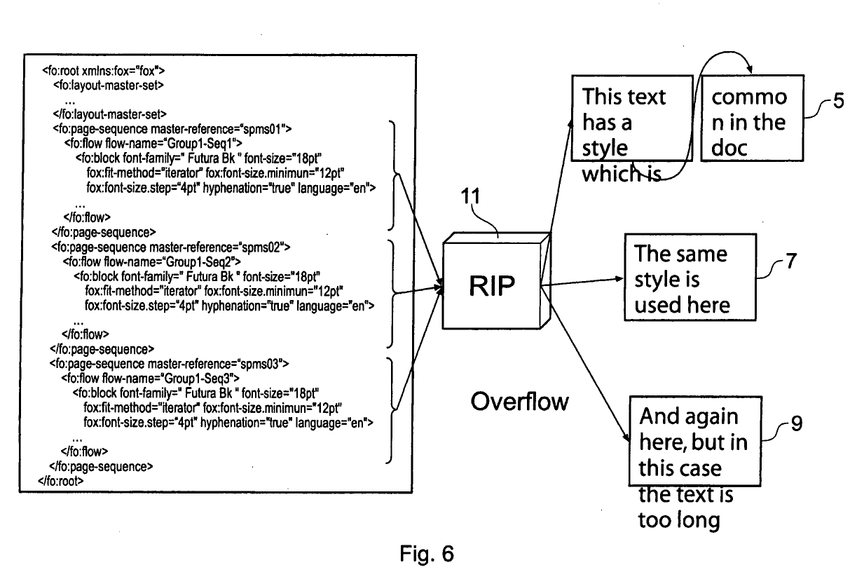

FIG. 6 schematically illustrates the initial result of processing the page description language for the copy-holes referred to in previous figures;

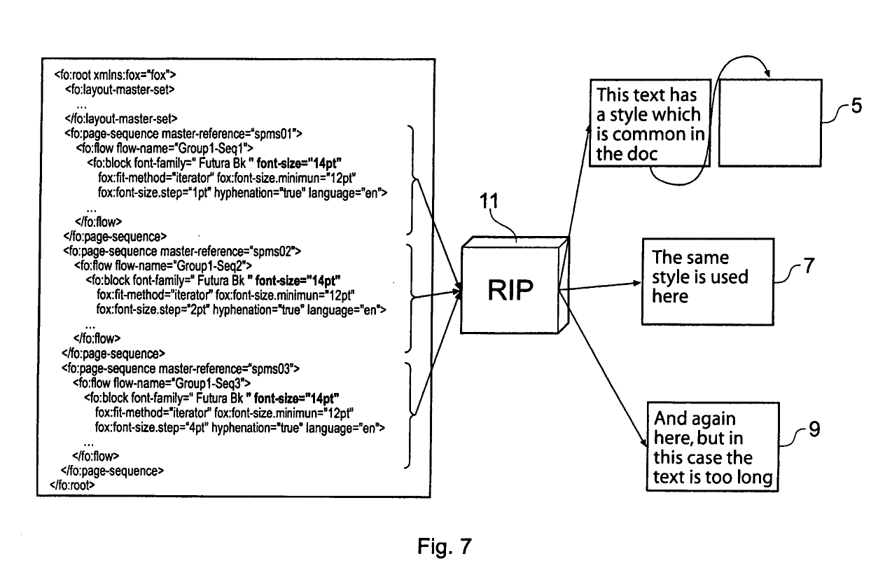

FIG. 7 schematically illustrates the result of modifying the page description language in accordance with the present invention and subsequently processing the modified language;

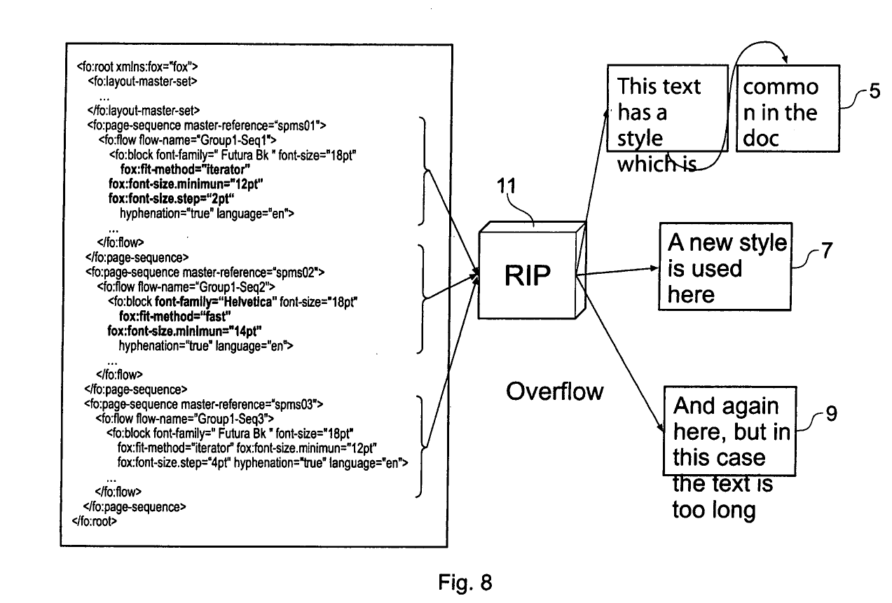

FIG. 8 schematically illustrates an embodiment of the present invention in which different style parameters are specified for individual copy-holes within a group; and

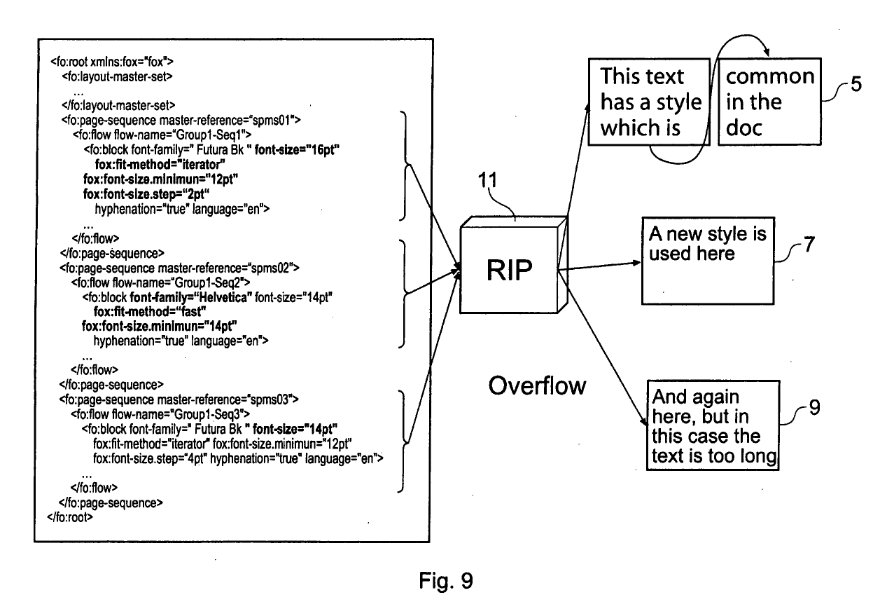

FIG. 9 illustrates the page description language of FIG. 8 after modification according to an embodiment of the present invention and the result of processing of that modified page description language.

FIG. 1 schematically illustrates how the location of an object on a page within a PPML document is specified. The area 1 on the page 3 in which the variable-data object is to be placed is referred to as a copy-hole. The copy-hole 1 has an origin 5 whose location on the page is specified in terms of x and y coordinates. The dimensions of the copy-hole 1 are then specified in terms of its Width and Height. If the object to be placed in the copy-hole 1 is a block of text, then the PPML further specifies the text attributes, such as font and font size.

In variable-data printing, it is quite likely that the different blocks of text that are to be selectively placed in the copy-hole will be of different lengths. For example, the same text may be provided in a number of different languages, so as to allow language specific documents to be produced. Alternatively, a completely different block of text may be provided dependent upon the subject matter of the document. There is therefore the need to ensure that the object to be placed in the copy-hole will fit the pre-determined copy-hole. In the case of variable text, the XSL-FO associated with the object is used to specify some properties and/or constraints to control how the re-sizing of the text will be applied. For example, if the desired style for the copy-hole is to use the font Times New Roman with a size of 18 pt, the XSL-FO may specify the constraint that the font size may be reduced to a minimum of 12 pt using a 4 pt step size. An example of the use of XSL-FO to implement such constraints is provided in the applicant's co-pending application GB0325473.7 the contents of which are incorporated herein by reference.

Whilst it is possible to re-size the variable-data objects to be placed within individual copy-holes to ensure that the objects fit within the pre-determined copy-hole size, this still allows, in the example of text, different sizes of text to be used across different copy-holes throughout the entirety of the document that were originally intended to be of a uniform font and font size, so as to create a uniformity of style across the entire document.

FIG. 2 schematically illustrates an example of the above mentioned problem, in which three separate copy-holes, expressed in PPML, are provided across two separate pages within a document. In the illustrated example, the first copy-hole 5 on page 1 is shown as being subdivided into two separate columns, with the text flowing from the first column to the second column. However, it will be appreciated that this need not be the case for every example. The remaining copy-holes 7, 9 are shown as single locations for text. The XSL-FO defining the style of the content of the copy-holes has specified an initial font size that has caused the text placed in the third copy-hole 9 on page n to exceed the defined copy-hole boundaries. Whilst it is possible, as previously mentioned, for the size of the text in each individual copy-hole to be adjusted according to constraints defined by the XSL-FO instructions, this would result in the text fitted within the third copy-hole 9 being of a different size to the text in the first and second copy-holes 5, 7. The possibility of re-ripping page 1 and applying the text attributes of the third copy-hole n to the text within the first and second copy-holes 5, 7 does not exist since in accordance with current systems as soon as page 1 has been ripped it would be printed.

To overcome this difficulty, in embodiments of the present invention the three copy-holes are linked together as a page-sequence within the PPML such that all three copy-holes are ripped at the same time. This allows the same copy-hole attributes to be applied across all three copy-holes. This is illustrated in FIG. 3, in which the same example as in FIG. 2 is used, but using the provided parameters, the text size has been reduced until the text to be placed within the third copy-hole 9 fits within the copy-hole. The resultant text attributes are also applied to the first and second copy-holes 5, 7, since these belong within the same page-sequence. Although this results in the text appearing in the first and second copy-holes 5, 7 not completely filling the space available within each copy-hole, this is preferable stylistically to having different font attributes across all three linked copy-holes.

In preferred embodiments, the individual sections of PPML instructions relating to each individual copy-hole within a page-sequence are rasterized in turn and are individually stored in cache memory provided by the RIP. This allows the rasterized data for individual copy-holes within a page-sequence to be subsequently retrieved if it transpires that style attributes from a later copy-hole need to be applied to the earlier ones. The amount of cache memory required to store the ripped data is relatively small compared to that required to store an entire ripped page.

FIGS. 4 to 9 illustrate further examples of fitting text within a number of linked copy-holes in accordance with embodiments of the present invention, together with the corresponding sections of PPML and XSL-FO. FIG. 4 illustrates the XSL-FO that defines each of the copy-holes within the pages of a multiple page sequence, as well as defining that the multiple pages do form part of a single page sequence. Each copy-hole is abstracted as a page, with its Width and Height specified, and their relationships specified as page-sequence-masters. As shown in FIG. 5, the content of each copy-hole or copy-hole sequence is stored within the FO page-sequence element, thus giving independence of content and of the “fit to box” techniques and parameters. As can be seen from the section of the FO page-sequence element corresponding to the first copy-hole 5, the specified font family is “Futura Bk” and the specified font size is 18 pt. The specified “fit to box” method is “iterator”, which signifies that the font attributes are modified iteratively according to defined parameters. In this case, those parameters include that the minimum font size is 12 pt and that the step size by which the font is reduced at each iteration is 4 pt. In this particular example, the same font attributes and “fit to box” method is specified for each of the copy-holes.

FIG. 6 schematically illustrates the processing by the “raster image processor” (RIP) 11 of the FO instructions by the RIP and the resultant layout in the corresponding copy-holes 5, 7, 9. This represents the first iteration of the ripping in which the “base” font size of 18 pts is applied to the text to be inserted in the copy-holes. As can be seen, this results in an overflow of the first and third copy-holes 5, 9. As a consequence, and in accordance with the defined “fit-method”, the ripping process is repeated with the applied font size reduced by the 4 pt step size to 14 pt, as can be seen from FIG. 7. This has the end result of fitting the text to all three copy-holes 5, 7, 9 as also shown in FIG. 7.

Individual copy-holes within the page-sequence may have different styles and different strategies to achieve the “fit to box”. This is illustrated in FIG. 8, in which the step size for the first copy-hole has been reduced to 2 pts and for the second copy-hole 7 the font family is now “Helvetica” and the “fit to box” method is specified as “fast”, which specifies that the font size is reduced immediately from the base font size of 18 pts to the specified minimum of 14 pt. The style and fit to box strategies for the third copy-hole 9 is the same as for the previous examples. As before, the result of the first pass by the RIP 11 results in an overflow in both the first and third copy-holes 5, 9. The result of the further iteration by the RIP 11 is shown in FIG. 9. As can be seen from the shown FO, the font size of the first copy-hole 5 has been reduced by 2 pts to 16 pt, the font size of the second copy-hole 7 has been reduced to the minimum point size of 14 pt, while the font size of the third copy-hole 9 has been reduced by the specified 4 pt step to 14 pt. As a result, the text now fits within the confines of each copy-hole.

1. A method of preparing a variable data document for publishing, the method comprising:
defining a plurality of data content areas within the document in which respective specified data objects are to be inserted, each data content area having a defined size;
for each data content area defining one or more style parameters to be applied to the specified data object and defining one or more style modification parameters;
associating a plurality of data content areas with one another; and
if, after applying the or each style parameter to the specified data objects for each of a data content area associated with one another, one or more data objects exceed the size of the respective data object areas, then modifying the or each style parameter of each associated data content area in accordance with the respective style modification parameters.

2. A method according to claim 1, wherein the same style parameters are defined for each associated data content area.

3. A method according to claim 1, wherein the same style modification parameters are defined for each associated data content area.

4. A method according to claim 1, wherein the step of modifying the style parameters for each associated data content area is repeated until each data object fits within the respective data content area.

5. A method according to claim 1, wherein the data content area is defined in PPML format.

6. A method according to claim 1, wherein the style parameters and style modification parameters are expressed in XSL-FO format.

7. A method according to claim 1 further comprising, subsequent to modifying the or each style parameter, rasterizing the document.

8. A computer program comprising a plurality of computer readable instructions that when executed by a computer cause the computer to perform the method of claim 1.

9. A computer program according to claim 8, wherein the computer program is embodied in a computer readable medium.

10. An apparatus for preparing a variable-data document for publishing, the apparatus comprising a document processor and a document buffer, the document processor being arranged to:
receive a plurality of data objects and to receive a plurality of input files, the input files defining a plurality of data content areas within the document, each data content area being associated with at least one other data content area, in which respective specified data objects are to be inserted, each data content area having a defined size, defining one or more style parameters to be applied to a specified data object and defining one or more style modification parameters;
apply the respective style parameters to each associated data object and storing the result in the document buffer;
determining if one or more data objects exceed the size of the respective data content area; and
if the size determination is positive, retrieving the stored data objects and modifying the applied style parameters of each associated data content area in accordance with the respective style modification parameters.
